(19) United States
(12) Patent Application Publication
(10) Pub. No.: US 2017/0212745 A1
(43) Pub. Date: Jul. 27, 2017

(54) SYSTEM AND METHOD FOR RELIABILITY, AVAILABILITY, AND SERVICEABILITY

(71) Applicant: INTERNATIONAL BUSINESS MACHINES CORPORATION, ARMONK, NY (US)

(72) Inventors: GORDAN G. GREENLEE, ENDICOTT, NY (US); ROBERT S. MILLIGAN, ERLANGER, KY (US); CHRISTOPHER L. MOLLOY, RALEIGH, NC (US); CRAIG A. NYGARD, RESEARCH TRIANGLE PARK, NC (US); STEVEN A. WAITE, MILWAUKEE, WI (US)

(21) Appl. No.: 15/004,156

(22) Filed: Jan. 22, 2016

(51) Int. Cl. G06F 9/445; G06F 17/30

(52) U.S. Cl. CPC G06F 8/65; G06F 17/30864; G06F 17/30539

(57) ABSTRACT

A system and method may include determining robustness of a target computer, gathering information regarding the target computer from a research engine, determining an order in which software packages are upgraded, dynamically adjusting the robustness of the target computer, returning data for a found component of the target computer, crawling the web looking for content related to a submission request, and updating data in a repository.

### BACKGROUND OF THE INVENTION

The present invention generally relates to a method of upgrading patterns such as software. More particularly, the present invention relates to reducing time, risk, and errors related to upgrading patterns.

Cost of computer outages can be expensive. These outages may be increased if software is out of date.

As can be seen, there is a need for a system and method for keeping patterns current.

### SUMMARY OF THE INVENTION

In one aspect, a method may include a research engine determining robustness of a target computer based on software execution patterns and complexity of relationships between all software packages installed on the target computer; and evaluating whether to upgrade at least one of the software packages installed in the target computer to be current while maintaining or improving the determined robustness of the target computer, wherein the robustness of the target computer is determined based on details from a plurality of servers attached to the target computer, devices linked to the target computer, and storage devices linked to the target computer, electronic switch information linked to the target computer, bus adapter information linked to the target computer, device driver multi-path software information for the target computer, real-time social media information, currency of the target computer, and cost details for all software and hardware components on the target computer; wherein a data analysis and rules engine gathers all information regarding the target computer from the research engine; in response to evaluating that an upgrade to at least one of the software packages are needed, the research engine determining an order in which software packages should be upgraded while maintaining or improving the determined robustness of the target computer, wherein the robustness of the target computer is dynamically adjusted based on a plurality of datasets across websites, APIs, and social media platforms indicative of user feedback directed to at least one of the software packages installed on the target computer, wherein in response to the research engine being configured to only leverage existing data for a component of the target computer robustness, the research engine returns data for a found component of the target computer robustness to the data analysis and rules engine, wherein in response to the research engine being configured to leverage existing data and enrich it based on social media and web results, a data miner crawls the web looking for content related to a submission request and returns results to the research engine, wherein in response to relevant data being found by the data miner, an end user is notified and allowed to manually enter data, and a repository containing the relevant data is updated and sent back to the research engine, and the research engine sends the updated data to the data analysis and rules engine, wherein the research engine continues to update the repository thereby supporting future results for the data and analysis engine.

These and other features, aspects and advantages of the present invention will become better understood with reference to the following drawings, description and claims.

### BRIEF DESCRIPTION OF THE DRAWINGS

FIG. 1 illustrates a method of updating software; and

FIG. 2 illustrates a system that can be used to implement the method of FIG. 1.

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method of upgrading patterns such as software on a computer.

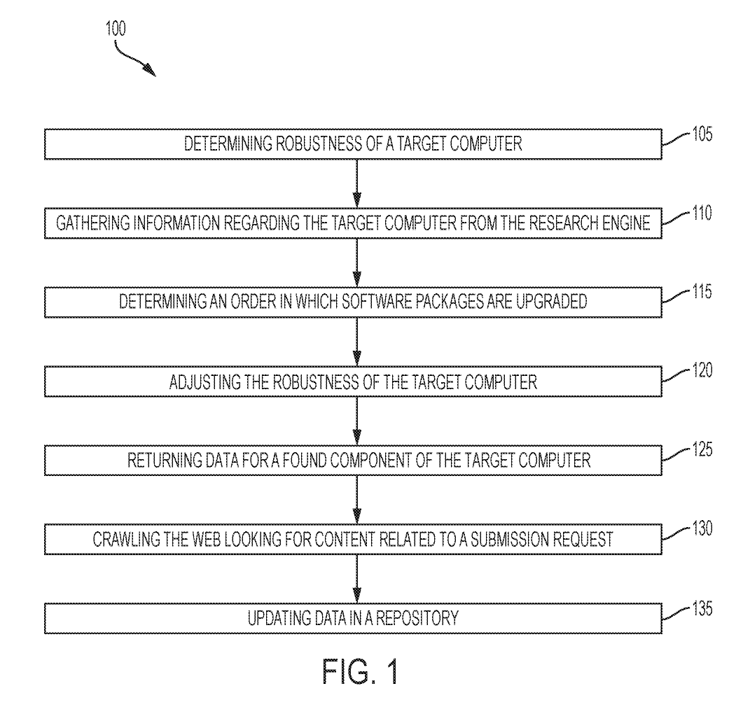

In FIG. 1, a method 100 may include a step 105 of determining robustness of a target computer. A step 110 may include gathering information regarding the target computer from a research engine. A step 115 may include determining an order in which software packages are upgraded. A step 120 may include adjusting the robustness of the target computer. A step 125 may include returning data for a found component of the target computer. A step 130 may include crawling the web looking for content related to a submission request. A step 135 may include updating data in a repository.

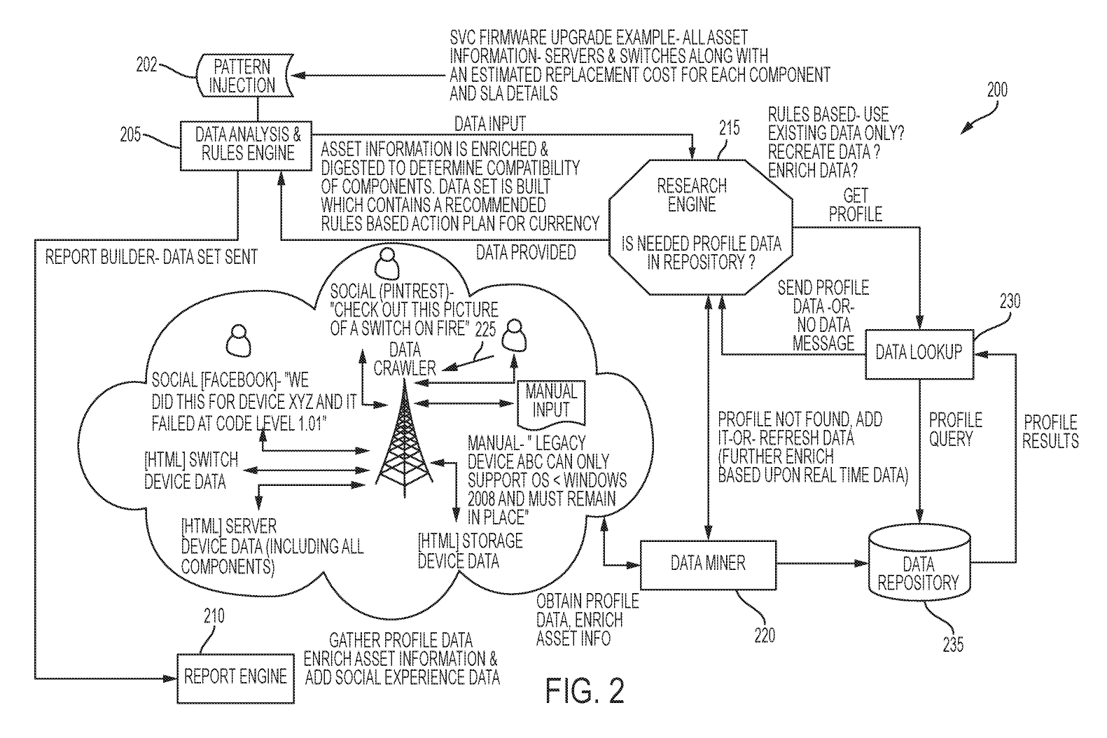

In FIG. 2, a Data Analytics and Rules Engine 205 can digest all input data (holistically) and create output data sets based upon needs of an injected pattern input 202. This engine 205 can work directly with a Research Engine 215 to obtained data for needed analytics. The Research Engine 215 can determine if request information exists in the repository, and if not, can take steps necessary to obtain the needed data. When data is needed it can be obtained from a variety of sources to build a profile—HTML, API, Social (Facebook/Tweeter/etc.), and manual input (for components not discoverable by other means). Data can be retained for future pattern remediation research/needs. A Data Look-up module 230 can provide data to the Research Engine 215 and can manage profile information leveraging in a Data Repository 235 as a data warehouse. A Data Miner 220 can work via a Data Crawler 225, and can provide data to the Research Engine 215 as a result of searching a variety of sources (via a Data Crawler Process)—HTML, API, Social (Facebook/Tweeter/etc.), and manual input (for components not discoverable by other means). The Data Crawler Process within the Data Crawler 225 can support Data Miner 220 efforts by directly searching a variety of sources on the web—HTML, API, Social (Facebook/Tweeter/etc.), and manual input (for components not discoverable by other means). The Data Repository 235 may be a Data warehouse 235 and may contain the needed profile information uncovered from Data Mining events. A Report Engine 210 can use the data assembled by Data Analytics and Rules Engine 205, and the Report engine can create the needed remediation output.

In an embodiment, the method 100 may improve RAS (Reliability, Availability, and Serviceability) by gathering input and using a rules based research engine with data look-up. This engine may create and maintain a profile for each injected pattern, which may be used as an additional input to the engine to determine what changes need to be made so RAS is improved. Analytics may be used to digest multiple sources of input and weigh them against an injected pattern to create a roadmap for currency remediation. This roadmap can identify the steps necessary to upgrade each pattern component needed to improve a customer's risk posture and an expected cost for the remediation.

RAS can leverage analytics based upon a rules set of industry best practices and customer specific requirements. RAS can leverage social media (as a feed) to understand impact based upon other's real time results from various social streams such as Facebook and Twitter and help the end user understand the right recommended level of currency as part of the process to ensure success—perhaps the most current upgrade/service pack/solution may not be ready to support a complex pattern. One way to assess this may be via real-time analysis of results from others. RAS may not install software, yet it can create a remediation plan with the steps necessary for currency for the injected software pattern along with an estimated cost, based upon input. RAS can help with confirmation of steps needed to achieve a specific level of software certification to avoid a violation.

In an embodiment, the method 100 can take multiple feeds/sources into account and continue to evolve in order to improve future pattern remediation outcome based upon customer needs. Patterns can be examined holistically to look at complexity between similar components to make certain a remediation for one application component does not adversely impact another.

Injected patterns can be application patterns (multiple applications that make up an ecosystem)—such as highly complex solutions. Social media inputs can allow for gathering of real-time input for the components to support the injected application pattern as leverage to improve success factors for the generated deliverable. Data inputs may be obtained from many sources for a holistic view—HTML, API, Social (Facebook/Tweeter/etc.), and manual input (for components not discoverable by other internet based means). Customer differentiators can be included. Business drivers can be taken as a factor into the rules engine.

It should be understood, of course, that the foregoing relates to exemplary embodiments of the invention and that modifications may be made without departing from the spirit and scope of the invention as set forth in the following claims.

1. A method for improving reliability, availability and serviceability for a target computer comprising:
creating a profile using a research engine for a software execution pattern on a computer processor on the target computer;
basing the profile for the software execution pattern on details for the software execution pattern from a plurality of servers attached to the target computer, devices linked to the target computer, and storage devices linked to the target computer, electronic switch information linked to the target computer, bus adapter information linked to the target computer, device driver multi-path software information for the target computer, real-time social media information for the software execution pattern, currency of the target computer, and cost details for all software and hardware components on the target computer;
wherein the research engine continues to update the profile in a repository thereby supporting future results for the profile;
improving the reliability, availability and serviceability of the target computer by adjusting the devices linked to the target computer, the storage devices linked to the target computer, electronic switch linked to the target computer, bus adapter linked to the target computer, device driver for the target computer, and software and hardware components on the target computer based on the updated profile.
